(19) United States
(12) Patent Application Publication
(10) Pub. No.: US 2015/0085239 A1
(43) Pub. Date: Mar. 26, 2015

(54) LIQUID CRYSTAL DISPLAY ELEMENT AND LIQUID CRYSTAL DISPLAY DEVICE

(71) Applicant: Sharp Kabushiki Kaisha, Osaka-shi, Osaka (JP)

(72) Inventors: Yuki Kawashima, Osaka-shi (JP); Yoshimizu Moriya, Osaka-shi (JP); Yasutoshi Tasaka, Osaka-shi (JP); Noritaka Ajari, Osaka-shi (JP)

(73) Assignee: Sharp Kabushiki KAisha, Osaki-shi, Osaka (JP)

(21) Appl. No.: 14/394,550

(22) PCT Filed: Apr. 22, 2013
(86) PCT No.: PCT/JP2013/061791

§ 371 Date: Oct. 15, 2014

(30) Foreign Application Priority Data
Apr. 27, 2012 (JP) 2012-103715

(51) Int. Cl. G02F 1/1343; G02F 1/1333; G02F 1/1362; G02F 1/1368

(52) U.S. Cl. CPC G02F 1/134309; G02F 1/1368; G02F 1/133345; G02F 1/136213; G02F 1/13439; G02F 2001/13606
USPC 349/139

(57) ABSTRACT

A liquid crystal display element (110) includes a common electrode (140). The common electrode (140) covers a location which faces at least one of at least a part of scanning lines (120) and at least a part of signal lines (119), has openings (141) at locations facing transparent pixel electrodes (130), and has a cutout section (142) at a pixel boundary region (146) in such a manner that the cutout section (142) exists at least at a part of the pixel boundary region (146) which part does not face the transparent pixel electrodes (130).

### TECHNICAL FIELD

The present invention relates to a liquid crystal display element and a liquid crystal display device, and particularly to a liquid crystal display element and a liquid crystal display device each of a vertical electric field type represented by a TN mode and a VA mode.

### BACKGROUND ART

Recently, liquid crystal display devices are used in many kinds of devices. Examples of such devices include televisions and mobile phones. A liquid crystal display device is a display device including a liquid crystal display element which controls orientation of liquid crystal by controlling an electric field generated across electrodes and consequently controls transmittance of light. For the liquid crystal display element, there are many kinds of methods for controlling orientation of liquid crystal. Such methods can be roughly classified into a vertical electric field type and a horizontal electric field type, in view of a direction in which an electric field is generated.

A liquid crystal display element of a vertical electric field type includes a pair of transparent substrates positioned to face each other and a liquid crystal layer sandwiched between the pair of transparent substrates. One of the pair of transparent substrates is provided with pixel electrodes. The other of the pair of transparent substrates is provided with a counter electrode. By applying a voltage across the pixel electrodes and the counter electrode, an electric field perpendicular to the liquid crystal layer, i.e. an electric field in a vertical direction is generated. By controlling intensity and direction of the electric field in the vertical direction, orientation of liquid crystal is controlled. Representative examples of the liquid crystal display element of a vertical electric field type include a liquid crystal display element of a TN (twisted nematic) mode and a liquid crystal display element of a VA (vertical alignment) mode.

As an example of the liquid crystal display element of a vertical electric field type, FIGS. 11 and 12 schematically illustrate a liquid crystal display element 200. (a) of FIG. 11 illustrates a plan view of the liquid crystal display element 200, and (b) of FIG. 11 illustrates a cross sectional view of the liquid crystal display element 200 taken along the line A-A of (a) of FIG. 11. (a) of FIG. 12 illustrates an enlarged view of a part of (b) of FIG. 11. (b) of FIG. 12 illustrates an enlarged view of a cross section of the liquid crystal display element 200 taken along a line on a scanning line 220 parallel to the line A-A of (a) of FIG. 11.

As illustrated in (b) of FIG. 11, the liquid crystal display element 200 includes a glass substrate 211 and a glass substrate 212 which are a pair of transparent substrates, and a liquid crystal layer 213 which is sandwiched between the glass substrate 211 and the glass substrate 212. As illustrated in (a) of FIG. 11, the glass substrate 211 is provided with signal lines 219, scanning lines 220, TFTs (thin film transistors) 223, pixel electrodes 230, and common electrodes 240.

The signal lines 219 are provided to be parallel to each other with a regular interval therebetween. The scanning lines 220 are provided to be parallel to each other with a regular interval therebetween. The signal lines 219 are orthogonal to the scanning lines 220. Consequently, on a surface of the glass substrate 211, rectangular regions each defined by one of the signal lines 219 and one of the scanning lines 220 are provided in a matrix manner. Each of the rectangular regions corresponds to one sub-pixel. One pixel includes three sub-pixels (of a red color, a green color, and a blue color, respectively).

One sub-pixel includes two TFTs. The TFTs are coplanar TFTs of a top gate type, and each include a gate electrode 223 which is a part of the scanning line 220, an SI path 221, and an SI path 222. One end of the SI path 221 is provided with a source electrode (not illustrated). The source electrode is connected with the signal line 219 via a contact hole (not illustrated). On the other hand, the SI path 222 is connected with a drain electrode 224. The drain electrode 224 is connected with a corresponding one of the pixel electrodes 230 via a contact hole (not illustrated).

While one of the scanning lines 220 is selected, an address signal is supplied to the one of the scanning lines 220, and data signals are sequentially supplied to the signal lines 219. Consequently, a voltage corresponding to the data signal is supplied to the SI path 222 and the pixel electrode 230, so that an electric field in accordance with the data signal is generated between the pixel electrode 230 and a counter electrode 225.

While none of the scanning lines 220 is selected, it is necessary for the liquid crystal display element 200 to maintain an electric field between the pixel electrode 230 and the counter electrode 225. In order to generate storage capacitance for maintaining this electric field, a plurality of common electrodes 240 are provided. The plurality of common electrodes 240 are provided on an identical layer where the scanning lines 220 are provided, and are made of the same non-transparent metal conductive material as the material of the scanning lines 220. The plurality of common electrodes 240 are provided to be parallel to the scanning lines 220. Each common electrode 240 is provided between adjacent ones of the scanning lines 220.

The liquid crystal display element of a horizontal electric field type includes a liquid crystal layer sandwiched between a pair of transparent substrates, as with the case of the liquid crystal display element of a vertical electric field type. However, the liquid crystal display element of a horizontal electric field type is different from the liquid crystal display element of a vertical electric field type in that one of the pair of transparent substrates is provided with pixel electrodes and common electrodes. In the liquid crystal display element of a horizontal electric field type, a voltage is applied across a pixel electrode and a corresponding common electrode in one of the transparent substrates, so that an electric field is generated in an in-plane direction of the liquid crystal layer, i.e. in a horizontal direction. Examples of the liquid crystal display element of a horizontal electric field type include a liquid crystal display element of an IPS (in-plane switching) mode and a liquid crystal display element of a FFS (fringe field switching) mode.

Patent Literature 1 describes a liquid crystal display element of a FFS mode in which an influence of a parasitic capacitance is reduced. The following description will discuss a feature of the invention of Patent Literature 1 with reference to FIGS. 13 and 14.

FIG. 13 is a view schematically illustrating a liquid crystal display element 300 of a FFS mode. (a) of FIG. 13 illustrates a plan view of the liquid crystal display element 300. (b) of FIG. 13 is a cross sectional view of the liquid crystal display element 300 taken along the line A-A of (a) of FIG. 13. FIG. 14 is an enlarged view of a part of (b) of FIG. 13.

As illustrated in (b) of FIG. 13, the liquid crystal display element 300 includes a glass substrate 311 and a glass substrate 312 which are a pair of transparent substrates, and a liquid crystal layer 313 which is sandwiched between the glass substrate 311 and the glass substrate 312. As illustrated in (a) of FIG. 13, the glass substrate 311 is provided with signal lines 319, scanning lines 320, TFTs, pixel electrodes 330, and a common electrode 340. The common electrode 340 is made of a conductive material which is transparent in a visible region.

The signal lines 319 are provided to be parallel to each other at regular intervals therebetween. The scanning lines 320 are provided to be parallel to each other at regular intervals therebetween. The signal lines 319 are orthogonal to the scanning lines 320. Consequently, on a surface of the glass substrate 311, rectangular regions each defined by one of the signal lines 319 and one of the scanning lines 320 are provided in a matrix manner. Each of the rectangular regions corresponds to one sub-pixel. One pixel includes three sub-pixels (of a red color, a green color, and a blue color, respectively).

One sub-pixel includes two TFTs. The TFTs are coplanar TFTs of a top gate type, and each include a gate electrode 323 which is a part of the scanning line 320, an SI path 321, and an SI path 322. The SI path 321, a source electrode, and the signal line 319 are connected with one another via a contact hole (not illustrated). On the other hand, the SI path 322 is connected with a drain electrode 324. The drain electrode 324 is connected with a pixel electrode 330 via a contact hole (not illustrated). The pixel electrode 330 has slits for generating an electric field between the pixel electrode 330 and the common electrode 340 which will be described later.

### CITATION LIST

### Patent Literatures

### [Patent Literature 1]

Japanese Patent Application Publication, Tokukai, No. 2008-209686 (published on Sep. 11, 2008)

### SUMMARY OF INVENTION

### Technical Problem

In the liquid crystal display element 200 having the above configuration, parasitic capacitances generated among the signal line 219, the scanning line 220, and the pixel electrode 230 deteriorate display quality. A description will be provided below as to this deterioration with reference to FIG. 12.

(a) of FIG. 12 is an enlarged view of a part of (b) of FIG. 11. (b) of FIG. 12 is an enlarged view of a cross section of the liquid crystal display element 200 taken along a line on the scanning line 220 parallel to the line A-A of (a) of FIG. 11.

As illustrated in (a) of FIG. 12, only an organic insulating film 217 exists between the signal line 219 and the pixel electrode 230. Consequently, a parasitic capacitance Csd 227 is generated between the signal line 219 and the pixel electrode 230.

As illustrated in (b) of FIG. 12, only an insulating film 216 and the organic insulating film 217 exist between the scanning line 220 and the pixel electrode 230. Consequently, a parasitic capacitance Cgd 228 is generated between the scanning line 220 and the pixel electrode 230.

These Csd 227 and Cgd 228 cause flickers and a crosstalk between pixels, thereby deteriorating display quality of the liquid crystal display element 200.

One sub-pixel has, in addition to Csd 227 and Cgd 228, a liquid crystal capacitance and a storage capacitance. The liquid crystal capacitance is generated between the pixel electrode 230 and the counter electrode 225. The storage capacitance is generated between the common electrode 240 and the SI path 222. A sum of the liquid crystal capacitance, the storage capacitance, Csd 227, and Cgd 228 is considered as a pixel capacitance. As a ratio of the parasitic capacitance is larger with respect to the pixel capacitance, the parasitic capacitance has a larger influence on display quality of the liquid crystal display element 200. In other words, when the pixel capacitance is increased by increasing the storage capacitance, the ratio of the parasitic capacitance with respect to the pixel capacitance can be decreased. Accordingly, it is possible to subdue the influence of the parasitic capacitance on display quality.

However, in order to design the liquid crystal display element 200 to have a larger storage capacitance, it is necessary to design the common electrode 240 to have a larger width (length of the common electrode 240 in a direction parallel to the signal line 219). Since the common electrode 240 is made of a non-transparent material, increasing the width of the common electrode 240 results in a narrower region which transmits backlight. Consequently, designing the liquid crystal display element 200 to have a larger storage capacitance so as to prevent the influence of the parasitic capacitance causes another problem that luminance of the liquid crystal display element 200 drops.

The liquid crystal display element 300 which is a liquid crystal display element of a horizontal electric field type includes the common electrode 340 so as to subdue the influence of the parasitic capacitance, and is characterized by a shape of the common electrode 340 and a position where the common electrode 340 is provided. On a plan view, the common electrode 340 is provided on a whole region other than the drain electrodes 324 and the contact holes (see (a) of FIG. 13). On the other hand, on a cross sectional view, the common electrode 340 is provided between (i) a layer where the signal lines 319 are provided and a layer where the scanning lines 320 are provided and (ii) a layer where the pixel electrodes 330 are provided (see (b) of FIG. 13).

Consequently, the signal lines 319 and the scanning lines 320 are shielded by the common electrode 340 from the pixel electrodes 330. As a result, Csd which is a parasitic capacitance between the signal line 319 and the pixel electrode 330 and Cgd which is a parasitic capacitance between the scanning line 320 and the pixel electrode 330 are subdued.

By subduing Csd and Cgd, it is possible to stabilize a voltage maintained at the common electrode 340. Therefore, it is possible to prevent deterioration in display quality of the liquid crystal display element 300.

On the other hand, as illustrated in FIG. 14, since the common electrode 340 is provided on a whole region other than the drain electrodes 324 and the contact holes, it is necessary for the common electrode 340 to transmit backlight 329a. An absorption ratio of the common electrode 340 is determined by (i) an absorption coefficient of a transparent conductive material constituting the common electrode 340 and (ii) a thickness of the common electrode 340. Out of the backlight 329a, light corresponding to the absorption ratio of the common electrode 340 is absorbed by the common electrode 340, and light transmitted by the common electrode 340 becomes backlight 329b. As described above, the liquid crystal display element 300 has a problem that luminance drops due to absorption of the backlight 329a into the common electrode 340. It should be noted that absorption of the backlight 329b by the pixel electrodes 330 is not considered here.

In addition, the invention described in Patent Literature 1 is premised on a liquid crystal display element of a FFS mode, and so is not applicable to a liquid crystal display element of a vertical electric field type.

The present invention was made in view of the foregoing problems. An object of the present invention is to provide a liquid crystal display element of a vertical electric field type and a liquid crystal display device each capable of subduing a parasitic capacitance between (i) scanning lines and signal lines and (ii) pixel electrodes, without sacrificing luminance of the liquid crystal display element.

### Solution to Problem

In order to solve the foregoing problems, a liquid crystal display element in accordance with one aspect of the present invention is a liquid crystal display element including a pair of transparent substrates and a liquid crystal layer provided between the pair of transparent substrates,

one of the pair of transparent substrates being provided with:

scanning lines;

signal lines orthogonal to the scanning lines;

driving elements connected with the signal lines and the scanning lines;

transparent pixel electrodes provided at a layer above a layer at which the scanning lines and the signal lines are provided, the transparent pixel electrodes being connected with the driving elements; and

a transparent common electrode,
the transparent common electrode being provided at a layer between (i) the scanning lines and the signal lines and (ii) the transparent pixel electrodes,
the transparent common electrode covering a location which faces at least one of at least a part of the scanning lines and at least a part of the signal lines,
the transparent common electrode having openings at locations facing the transparent pixel electrodes, respectively, and
the transparent common electrode having a cutout section at a pixel boundary region in such a manner that the cutout section exists at least at a part of the pixel boundary region which part does not face the transparent pixel electrodes, the pixel boundary region being a region between adjacent ones of the transparent pixel electrodes which ones are adjacent in a signal line direction,
the other of the pair of transparent substrates being provided with a counter electrode.

With the arrangement, in the liquid crystal display element in accordance with one aspect of the present invention, the transparent common electrode is provided at a layer between (i) the scanning lines and the signal lines and (ii) the transparent pixel electrodes. Furthermore, at least one of at least a part of the scanning lines and at least a part of the signal lines is covered with the transparent common electrode. In the liquid crystal display element having this configuration, in a case where at least a part of the scanning line is covered with the transparent common electrode, a part of the scanning line and the pixel electrode are shielded from each other by the transparent common electrode. Similarly, in a case where at least a part of the signal line is covered with the transparent common electrode, a part of the signal line and the pixel electrode are shielded from each other by the transparent common electrode. This subdues a parasitic capacitance between (i) at least one of at least a part of the scanning line and at least a part of the signal line and (ii) the pixel electrode.

Furthermore, the transparent common electrode has openings at locations facing the transparent pixel electrodes. This allows more amount of light to enter the liquid crystal layer without being transmitted by the transparent common electrode. Consequently, the liquid crystal display element has improved luminance.

As described above, with the liquid crystal display element in accordance with one aspect of the present invention, it is possible to subdue a parasitic capacitance between (i) the scanning line and the signal line and (ii) the pixel electrode, without sacrificing luminance of the liquid crystal display element of a vertical electric field type.

Furthermore, with the arrangement, the transparent pixel electrode included in the liquid crystal display element in accordance with one embodiment of the present invention has a cutout section at a pixel boundary region in such a manner that the cutout section exists at least at a position of the pixel boundary region which position does not face the transparent pixel electrode. This allows regulating an electric field generated in the pixel boundary region, and consequently allows regulating alignment of liquid crystal molecules included in the pixel boundary region. Therefore, it is possible to subdue display deficiency such as roughness due to variations in alignment of liquid crystal molecules.

For a fuller understanding of the nature and advantages of the invention, reference should be made to the ensuing detailed description taken in conjunction with the accompanying drawings.

### Advantageous Effects of Invention

The present invention allows a liquid crystal display element of a vertical electric field type to subdue a parasitic capacitance between the scanning line and the pixel electrode and a parasitic capacitance between the signal line and the pixel electrode, without sacrificing luminance. Therefore, the present invention yields an effect that a liquid crystal display element and a liquid crystal display device each of a vertical electric field type can improve display quality without sacrificing luminance.

Furthermore, the present invention allows regulating an electric field generated at the pixel boundary region which is a region between adjacent ones of the transparent pixel electrodes which are adjacent in a signal line direction, and consequently allows regulating alignment of liquid crystal molecules included in the pixel boundary region. Therefore, the present invention allows regulating a center of alignment of liquid crystal molecules in the pixel boundary region, and allows subduing display deficiency such as roughness due to variations in alignment of liquid crystal molecules.

### BRIEF DESCRIPTION OF DRAWINGS

(a) of FIG. 1 is a plan view schematically illustrating a liquid crystal display element in accordance with one embodiment of the present invention. (b) of FIG. 1 is a cross sectional view schematically illustrating a cross section of the liquid crystal display element.

(a) of FIG. 2 is a view schematically illustrating how parasitic capacitance Csd between a signal line and a pixel electrode is subdued by a common electrode in the liquid crystal display element. (b) of FIG. 2 is a view schematically illustrating how parasitic capacitance Cgd between a scanning line and a pixel electrode is subdued by a common electrode. (c) of FIG. 2 is a view schematically illustrating how backlight is transmitted in the liquid crystal display element.

FIG. 3 is a plan view schematically illustrating a liquid crystal display element in accordance with one embodiment of the present invention.

FIG. 4 is a plan view schematically illustrating a liquid crystal display element in accordance with one embodiment of the present invention.

(a) of FIG. 5 is a plan view schematically illustrating a liquid crystal display element in accordance with one embodiment of the present invention. (b) of FIG. 5 is a cross sectional view of the liquid crystal display element.

(a) of FIG. 6 is a plan view schematically illustrating a liquid crystal display element in accordance with one embodiment of the present invention. (b) and (c) of FIG. 6 are cross sectional views of the liquid crystal display element.

FIG. 7 is a view illustrating an optical microscopic image of a liquid crystal display element in accordance with one embodiment of the present invention.

FIG. 8 is a plan view schematically illustrating a liquid crystal display element in accordance with one embodiment of the present invention.

FIG. 9 is a plan view schematically illustrating a liquid crystal display element in accordance with one embodiment of the present invention.

FIG. 10 is a plan view schematically illustrating a liquid crystal display element in accordance with one embodiment of the present invention.

(a) of FIG. 11 is a plan view schematically illustrating a conventional liquid crystal display element. (b) of FIG. 11 is a cross sectional view of the liquid crystal display element.

(a) of FIG. 12 is a view schematically illustrating parasitic capacitance Csd between a signal line and a pixel electrode in a conventional liquid crystal display element. (b) of FIG. 12 is a view schematically illustrating parasitic capacitance Cgd between a scanning line and a pixel electrode.

(a) of FIG. 13 is a plan view schematically illustrating another conventional liquid crystal display element. (b) of FIG. 13 is a cross sectional view of the liquid crystal display element.

FIG. 14 is a view illustrating how backlight is transmitted in another conventional liquid crystal display element.

### DESCRIPTION OF EMBODIMENTS

The following description will discuss embodiments of the present invention with reference to FIGS. 1 to 10.

### First Embodiment

### (Outline of Liquid Crystal Display Element 10)

With reference to FIGS. 1 and 2, the following description will discuss a liquid crystal display element 10 in accordance with one embodiment of the present invention. (a) of FIG. 1 is a plan view schematically illustrating the liquid crystal display element 10. (b) of FIG. 1 is a cross sectional view schematically illustrating a cross section of the liquid crystal display element 10 taken along the line A-A of (a) of FIG. 1. (a) of FIG. 2 is an enlarged view of a part of (b) of FIG. 1. (b) of FIG. 2 is an enlarged view of a cross section of the liquid crystal display element 10 taken along a line on a scanning line 20 parallel to the line A-A of (a) of FIG. 1. (c) of FIG. 2 is an enlarged view of a part of (b) of FIG. 1, similarly with (a) of FIG. 2. (c) of FIG. 2 illustrates how backlight 29 enters a liquid crystal layer 13.

The liquid crystal display element 10 is a VA mode liquid crystal display element which is one of liquid crystal display elements of a vertical electric field type. The liquid crystal display element 10 employs dot-inversion driving as a driving method. As illustrated in (b) of FIG. 1, the liquid crystal display element 10 includes a glass substrate 11 (one of a pair of transparent substrates), a glass substrate 12 (the other of the pair of transparent substrates), and a liquid crystal layer 13 sandwiched between the glass substrate 11 and the glass substrate 12. A surface of the glass substrate 11 which surface is opposite to a surface thereof closer to the liquid crystal layer 13 is provided with a polarization plate (not illustrated) closely attached to that surface. Similarly, a surface of the glass substrate 12 which surface is opposite to a surface thereof closer to the liquid crystal layer 13 is provided with a polarization plate (not illustrated) closely attached to that surface. The liquid crystal display element 10 further includes a backlight (not illustrated) for emitting white light to the polarization plate closely attached to the glass substrate 11.

On a surface of the glass substrate 12 which surface is closer to the liquid crystal layer 13, a color filter 26 and a counter electrode 25 are laminated. The color filter 26 is a filter which selectively transmits light with a wavelength range of red, green, or blue out of white light which comes from the backlight and is transmitted by the liquid crystal layer 13. Although not illustrated in (b) of FIG. 1, the color filter 26 is constituted by positioning red, green, and blue color filters in a matrix manner. The color filter 26 preferably includes a black matrix as well as the red, green, and blue color filters.

The liquid crystal display element 10 is characterized by a shape of a common electrode 40 (transparent common electrode) included in the glass substrate 11 and a position where the common electrode 40 is provided. Accordingly, the following description will discuss individual members laminated on the glass substrate 11 in details. A configuration known as a VA mode liquid crystal display element may be applied to the glass substrate 12 and the liquid crystal layer 13.

### (Configuration of Glass Substrate 11)

On a surface of the glass substrate 11 which surface is closer to the liquid crystal layer 13, a base coat (BC) 14, a plurality of SI paths 21, a plurality of SI paths 22, a first insulating film 15, a plurality of scanning lines 20, a second insulating film 16, a plurality of signal lines 19, an organic insulating film 17, the common electrode 40, a third insulating film 18, and pixel electrodes 30 (transparent pixel electrodes) are sequentially laminated.

The signal lines 19 are provided to be parallel to each other at regular intervals therebetween, which will be detailed later. Similarly, the scanning lines 20 are provided to be parallel to each other at regular intervals therebetween. The signal lines 19 are orthogonal to the scanning lines 20 on a plan view. A rectangular region defined by one of the signal lines 19 and one of the scanning lines 20 corresponds to one sub-pixel.

Since (b) of FIG. 1 is a cross sectional view of the liquid crystal display element 10 taken along the line A-A, (b) of FIG. 1 does not illustrate the scanning lines 20. The scanning lines 20 are provided on the first insulating film 15. Similarly, (b) of FIG. 1 does not illustrate the SI paths 21. The SI paths 21 are provided on the same layer where the SI paths 22 are provided.

### (TFT)

Two TFTs each serving as an element for driving the liquid crystal display element 10 are provided with respect to each sub-pixel region. Each TFT includes a gate electrode 23, the SI path 21, the SI path 22, and a drain electrode 24. The SI path 21 and the signal line 19 are connected with each other via a contact hole (not illustrated). In the TFT included in the liquid crystal display element 10, the signal line 19 corresponds to a source electrode. One end of the SI path 22 is connected with the drain electrode 24. The drain electrode 24 is connected with the pixel electrode 30 via a contact hole (not illustrated).

On the surface of the glass substrate 11, the BC 14, the SI paths 21, and the SI paths 22 are formed firstly. The SI paths 21 and the SI paths 22 are each made of silicon. The BC 14 is made of, for example, Ta₂O₅. BC14 serves as a protecting film for protecting the surface of the glass substrate 11. Besides, when patterns of the SI paths 21 and the SI paths 22 are formed, the BC14 also serves as an etching stopper.

At an interface among (i) the gate electrode 23 which is a part of the scanning line 20, (ii) the SI path 21, and (iii) the SI path 22, there are provided a gate insulating layer and a channel layer which are not illustrated in (a) of FIG. 1.

### (Scanning Line 20)

The scanning lines 20 and the first insulating film 15 are provided on the SI paths 21, the SI paths 22, and the BC 14. The scanning lines 20 are provided to be parallel to each other with a regular interval therebetween. The scanning lines 20 are orthogonal in direction to the SI paths 22.

Each of the TFTs is provided near an intersection between the scanning line 20 and the signal line 19.

It is preferable that the scanning lines 20 have high conductivity and are made of a metal material. Examples of the metal material for the scanning lines 20 include aluminum, molybdenum, chrome, tungsten, and titanium. By forming a laminate film made of a plurality of these metal materials, it is possible to form the scanning lines 20 having high conductivity. Another example of the material for the scanning lines 20 may be a compound having conductivity.

The scanning lines 20 are provided on the first insulating film 15. The first insulating film 15 is made of SiNₓ or SiO₂. It is necessary for the first insulating film 15 to transmit backlight entering the liquid crystal display element 10. In order not to sacrifice luminance of the liquid crystal display element 10, it is preferable that the first insulating film 15 has low optical absorbency with respect to light in a visible range.

The second insulating film 16 is provided on the first insulating film 15. The second insulating film 16 is an interlayer insulating film which insulates the scanning lines 20 from the signal lines 19 (mentioned later). The second insulating film 16 is made of SiNₓ or SiO₂, similarly with the first insulating film 15. It is preferable that the second insulating film 16 has low optical absorbency with respect to light in a visible range, similarly with the first insulating film 15.

### (Signal Line 19)

The signal lines 19 are provided on the second insulating film 16. The signal lines 19 are provided to be parallel to each other at regular intervals therebetween. The signal lines 19 are orthogonal to the scanning lines 20 (see (a) of FIG. 1). Consequently, on the glass substrate 11, rectangular regions each defined by one of the signal lines 19 and one of the scanning lines 20 are provided in a matrix manner. Each of the rectangular regions corresponds to one sub-pixel. One pixel includes three sub-pixels (of a red color, a green color, and a blue color, respectively).

Each sub-pixel includes the aforementioned TFTs. The SI path 21 included in each TFT and the signal line 19 are electrically connected with each other via a contact hole (not illustrated). The contact hole has a shape which penetrates the first insulating film 15 and the second insulating film 16.

It is preferable that the signal lines 19 have high conductivity and are made of a metal material, similarly with the scanning lines 20. Examples of the metal material for the signal lines 19 include aluminum, molybdenum, chrome, tungsten, and titanium. By forming a laminate film made of a plurality of these metal materials, it is possible to form the signal lines 19 having high conductivity. Another example of the material for the signal lines 19 may be a compound having conductivity.

The organic insulating film 17 which is transparent is provided on the signal lines 19. The organic insulating film 17 is an interlayer insulating film between the signal lines 19 and the common electrode 40 (mentioned later). It is preferable that the organic insulating film 17 is larger in thickness than the first insulating film 15, the second insulating film 16, and the third insulating film 18. By forming the organic insulating film 17 to be thick, it is possible to planarize unevenness on a surface of the second insulating film 16 due to formation of the signal lines 19, the scanning lines 20 etc. The organic insulating film is characterized in that it is easier to be formed as a planar-surfaced thick film than SiNₓ or SiO₂ which constitutes other insulating film.

A region on a surface of the glass substrate 11 on which region pixels are provided in a matrix manner is hereinafter referred to as a pixel-provision region.

### (Common Electrode 40)

The common electrode 40 is provided on the organic insulating film 17. As illustrated in (a) of FIG. 1, the common electrode 40 has openings 41 each corresponding to one sub-pixel. At a part of a region where the opening 41 is provided, the drain electrode 24 and a contact hole (not illustrated) each for electrically connecting the corresponding SI path 22 with the corresponding pixel electrode 30 (mentioned later) are provided. In other words, the common electrode 40 has the openings 41 respectively at least at regions where the contact holes are provided.

Since the opening 41 is provided at the region where the contact hole is provided, it is possible to electrically insulate the SI path 22, the drain electrode 24, the pixel electrode 30, and the common electrode 40 from one another. Since the SI path 22, the drain electrode 24, the pixel electrode 30, and the common electrode 40 have different potentials, it is necessary to insulate them from one another in order to prevent leakages among them.

The opening 41 is not limited in its shape and its number as long as the opening 41 has a shape which secures electric insulation among the SI path 22, the drain electrode 24, the pixel electrode 30, and the common electrode 40. However, it should be noted that in a case where the common electrode 40 has a plurality of openings 41 with respect to each sub-pixel, there is a possibility that the size of a storage capacitance is not uniform among sub-pixels. In a case where the size of a storage capacitance is not uniform among sub-pixels, there is a possibility that the unevenness is recognized as display unevenness by a user. Therefore, it is preferable that the common electrode 40 has one opening 41 with respect to each sub-pixel.

The common electrode 40 is an electrode by which individual sub-pixels have storage capacitances. The storage capacitance is necessary for maintaining an electric field generated at a portion of the liquid crystal layer 13 which portion corresponds to the sub-pixel while an address signal is not supplied to the signal line 19.

The common electrode 40 is provided on a whole of the pixel-provision region except for the openings 41. Accordingly, the liquid crystal display element 10 includes one common electrode 40, and individual parts of the common electrode 40 which parts correspond to respective sub-pixels have the same potential.

The common electrode 40 is made of indium tin oxide (ITO) or indium zinc oxide (IZO) which is a transparent conductive material. Since the common electrode 40 is provided on the pixel-provision region except for the openings 41, the common electrode 40 preferably has a good optical transmittance in a visible region. Besides, the common electrode 40 preferably has a good electric conductivity. Even if the transparent conductive material is other than ITO and IZO, the transparent conductive material can be used for the common electrode 40 as long as the transparent conductive material has such a good optical transmittance and such a good electric conductivity.

The liquid crystal display element 10 is characterized by the common electrode 40. What effect is yielded by the common electrode 40 included in the liquid crystal display element 10 will be described later.

The third insulating film 18 is provided on the common electrode 40. The third insulating film 18 is an interlayer insulating film which insulates the common electrode 40 from the pixel electrodes 30. The third insulating film 18 is made of SiNₓ or SiO₂, similarly with the first insulating film 15 and the second insulating film 16. The third insulating film 18 preferably has a low optical absorbency with respect to light in a visible region, similarly with the first insulating film 15 and the second insulating film 16.

### (Pixel Electrode 30)

The pixel electrodes 30 are provided on the third insulating film 18. One pixel electrode is provided for one sub-pixel. Consequently, the pixel electrodes 30 are provided on the pixel-provision region in a matrix manner.

The pixel electrode 30 is electrically connected with the SI path 22 included in the TFT via the drain electrode 24 and the contact hole. It is preferable that the drain electrode 24 and the contact hole are provided at a central part of a sub-pixel region defined by the signal line 19 and the scanning line 20 (see (a) of FIG. 1). This is related to the fact that a region where the drain electrode 24 and the contact hole are provided does not transmit light.

Although not detailed, the liquid crystal display element 10 employing a VA mode is preferably designed such that each sub-pixel region on the counter electrode 25 has an alignment regulating section at a center of the sub-pixel region. The alignment regulating section may be a hole or a protrusion (rib). The alignment regulating section regulates alignment of liquid crystal molecules. While the alignment regulating section can improve an alignment property of liquid crystal, optical transmittance drops at a region where the hole is provided. By causing a position where the alignment regulating section is provided on the counter electrode 25 to correspond to a position where the drain electrode 24 and the contact hole are provided on the pixel electrode 30, it is possible to subdue a loss in transmitted light in the liquid crystal display element 10. That is, it is possible to increase luminance of the liquid crystal display element 10.

The position of the hole included in the counter electrode 25 is not necessarily a center of the sub-pixel region. The number of the hole included in the counter electrode 25 may be two or more with respect to each sub-pixel region. The shape of the hole is not limited and may be elliptic. In these cases, it is preferable that the position where the drain electrode 24 and the contact hole are provided does not correspond to the center of the sub-pixel region but corresponds to the position where the hole is provided.

Alternatively, in order to regulate alignment of liquid crystal, the counter electrode 25 may include a protrusion instead of the hole. In this case, it is preferable that the position where the drain electrode 24 and the contact hole are provided corresponds to the position where the protrusion is provided.

In a case of a liquid crystal display element employing a TN mode, it is preferable that the drain electrode 24 and the contact hole are provided near an outer periphery of the sub-pixel region. This allows reducing an influence on alignment of liquid crystal.

The contact hole penetrates the first insulating film 15, the second insulating film 16, the organic insulating film 17, and the third insulating film 18, thereby connecting the drain electrode 24 with the pixel electrode 30.

The pixel electrodes 30 are made of ITO or IZO. The pixel electrodes 30 are provided at a region of the liquid crystal display element 10 which region transmits light. Therefore, it is preferable that the pixel electrode 30 has good optical transmittance in a visible region. In addition, it is preferable that the pixel electrode 30 has good electrical conductivity. A transparent conductive material having such good optical transmittance and electrical conductivity can be used as the pixel electrode 30 even when the material is other than ITO and IZO.

Furthermore, on the pixel electrode 30 and the third insulating film 18, there is provided an alignment film (not illustrated) for improving alignment of liquid crystal molecules.

### (Effects of Common Electrode 40)

Effects yielded by the liquid crystal display element 10 including the common electrode 40 are subdual of a parasitic capacitance, securement of a suitable storage capacitance, and improvement of luminance of the liquid crystal display element. Individual effects will be described below.

### (Subdual of Parasitic Capacitance)

On a cross sectional view of the liquid crystal display element 10, the common electrode 40 is provided between the signal line 19 and the pixel electrode 30 and between the scanning line 20 and the pixel electrode 30 (see (b) of FIG. 1). On the other hand, on a plan view of the liquid crystal display element 10, the common electrode is provided on a whole region of the pixel-provision region other than the openings 41 (see (a) of FIG. 1).

Therefore, on a cross section taken along the line A-A of (a) of FIG. 1, the signal line 19 and the pixel electrode 30 are shielded from each other by the common electrode 40 (see (a) of FIG. 2). Consequently, a parasitic capacitance Csd27 generated between the signal line 19 and the pixel electrode 30 is subdued. On a cross section taken along a line on the scanning line 20 parallel to the line A-A of (a) of FIG. 1, the scanning line 20 and the pixel electrode 30 are shielded from each other by the common electrode 40 (see (b) of FIG. 2). Consequently, a parasitic capacitance Cgd28 between the scanning line 20 and the pixel electrode 30 is subdued.

As described above, by the liquid crystal display element 10 including the common electrode 40, the parasitic capacitances Csd27 and Cgd28 are subdued. Consequently, deterioration in display quality of the liquid crystal display element 10 due to Csd27 and Cgd28 is subdued. That is, the common electrode 40 yields an effect of improving the display quality of the liquid crystal display element 10.

### (Securement of Storage Capacitance)

In the liquid crystal display element 10, a storage capacitance Ccs is provided between the common electrode 40 and the pixel electrodes 30. The common electrode 40 and the pixel electrodes 30 overlap each other at a large region other than the openings 41. Therefore, in the liquid crystal display element 10, it is easy to provide Ccs with a sufficient size. It should be noted that there is provided the organic insulating film 17 with a large thickness between the common electrode 40 and the SI path. Accordingly, a capacitance provided between the common electrode 40 and the SI path is very small.

In order that the liquid crystal display element 10 has good display quality, there is a preferable range of a size of Ccs. In the liquid crystal display element 10, it is possible to change Ccs freely by changing a size of the openings 41 of the common electrode 40. Formation of the openings 41 with a larger size downsizes a region where the common electrode 40 and the pixel electrodes 30 overlap, resulting in smaller Ccs. On the other hand, formation of the openings 41 with a smaller size enlarges the region where the common electrode 40 and the pixel electrodes 30 overlap, resulting in larger Ccs.

Assume that a liquid crystal capacitance between the pixel electrode 30 and the counter electrode 25 is Cpix. It is preferable that a relation 0.6×Cpix≦Ccs≦0.95×Cpix is met.

By meeting a relation 0.6×Cpix≦Ccs, the liquid crystal display element 10 can have Ccs in a size sufficient to satisfy display quality. In other words, it is possible to maintain a stable electric field even when an address signal is not supplied to the scanning lines 20. This prevents generation of flickers, so that the liquid crystal display element 10 can have satisfactory display quality.

In order to meet the relation 0.6×Cpix≦Ccs, it is necessary to set an area of the common electrode 40 on a plan view to be larger than a predetermined area which meets a relation Ccs=0.6×Cpix. Enlarging the area of the common electrode 40 indicates downsizing an area of the openings 41. Downsizing the area of the openings 41 in the common electrode 40 reduces an electric resistance across both ends of the common electrode 40. This allows subduing generation of a crosstalk between sub-pixels. Consequently, the liquid crystal display element 10 can have satisfactory display quality.

On the other hand, by meeting a relation Ccs≦0.95×Cpix, it is possible to sufficiently charge the storage capacitor during a period in which an address signal is supplied to the scanning line 20. This allows suitably maintaining an electric field for controlling the liquid crystal layer 13 even during a period in which an address signal is not supplied to the scanning line 20.

Assume a case where it is necessary to set the area of the openings 41 to be large in order to set Ccs in a suitable range. In this case, the area of the common electrode 40 would be downsized and there would be a possibility that an electric resistance across both ends of the common electrode 40 increases. In this case, by forming the common electrode 40 to have a larger thickness, it is possible to reduce the electric resistance across both ends of the common electrode 40.

### (Improvement of Luminance)

The common electrode 40 included in the liquid crystal display element 10 is made of ITO or IZO which is a transparent conductive material. Furthermore, the common electrode 40 includes the openings 41, and on a plan view of the glass substrate 11, at least a part of the openings 41 is provided at a region where the pixel electrodes 30 are provided.

As illustrated in a cross section illustrated in (c) of FIG. 2, the openings 41 allow the backlight 29 incident to the liquid crystal display element 10 to enter the liquid crystal layer 13 without being absorbed by the common electrode 40.

On the other hand, even at a region where the backlight 29 incident to the liquid crystal display element 10 is transmitted by the common electrode 40 before entering the liquid crystal layer 13, luminance of the liquid crystal display element 10 does not drop greatly since the common electrode 40 has good optical transmittance.

As described above, since the common electrode 40 included in the liquid crystal display element 10 is made of a transparent conductive material and includes the openings 41, the liquid crystal display element 10 does not sacrifice luminance unlike a conventional liquid crystal display element including a common electrode made of a metal material.

A part of the openings 41 may be provided at a region other than the region where the pixel electrodes 30 are provided. However, it is preferable that at least a part of the openings 41 is provided at a region where the pixel electrodes 30 are provided together with contact holes 24.

As described above, since the liquid crystal display element 10 of a vertical electric field type includes the common electrode 40, the liquid crystal display element 10 can have a storage capacitance desirable for attaining satisfactory display quality while subduing a parasitic capacitance between (i) the scanning line and the signal line and (ii) the pixel electrode. Consequently, the liquid crystal display element 10 of a vertical electric field type can have improved display quality.

The liquid crystal display element 10 is not limited to a VA mode liquid crystal display element. The present invention is applicable to any liquid crystal display element of a vertical electric field type.

A liquid crystal display device in accordance with one aspect of the present invention may include the liquid crystal display element 10. By the liquid crystal display device including the liquid crystal display element 10, the liquid crystal display device can have improved display quality without sacrificing luminance.

### Second Embodiment

### (Liquid Crystal Display Element 50)

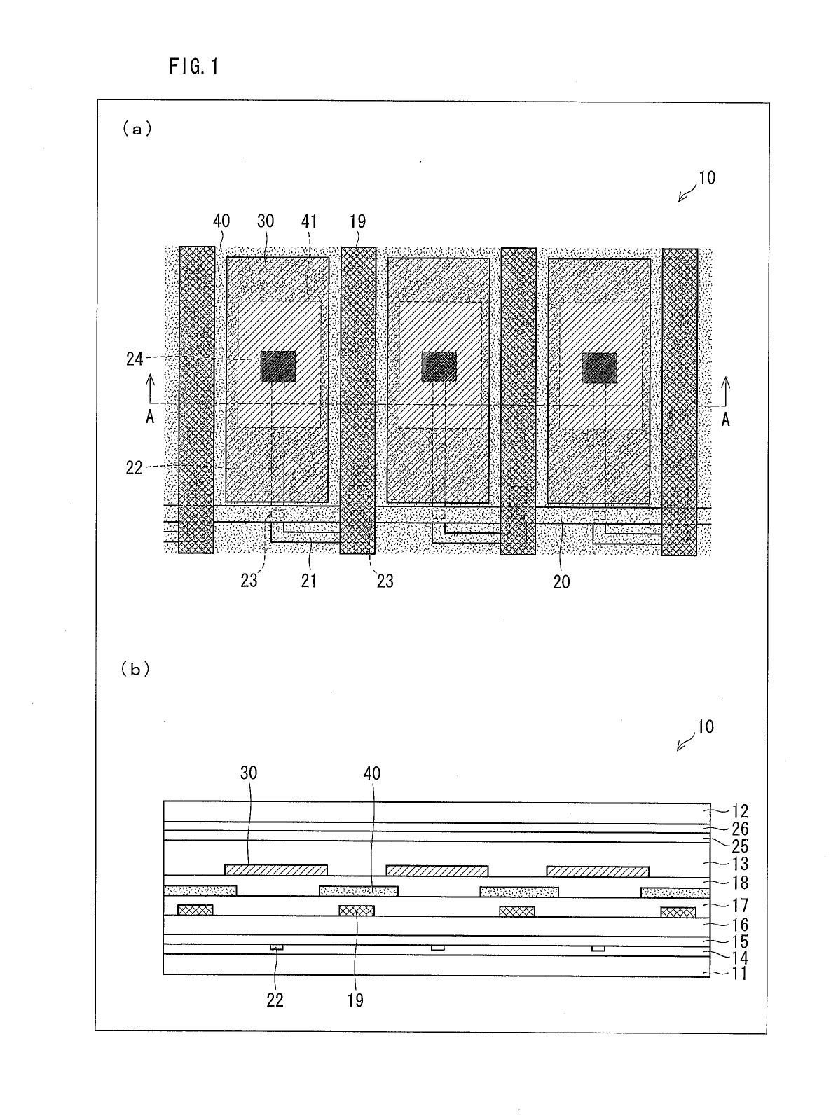

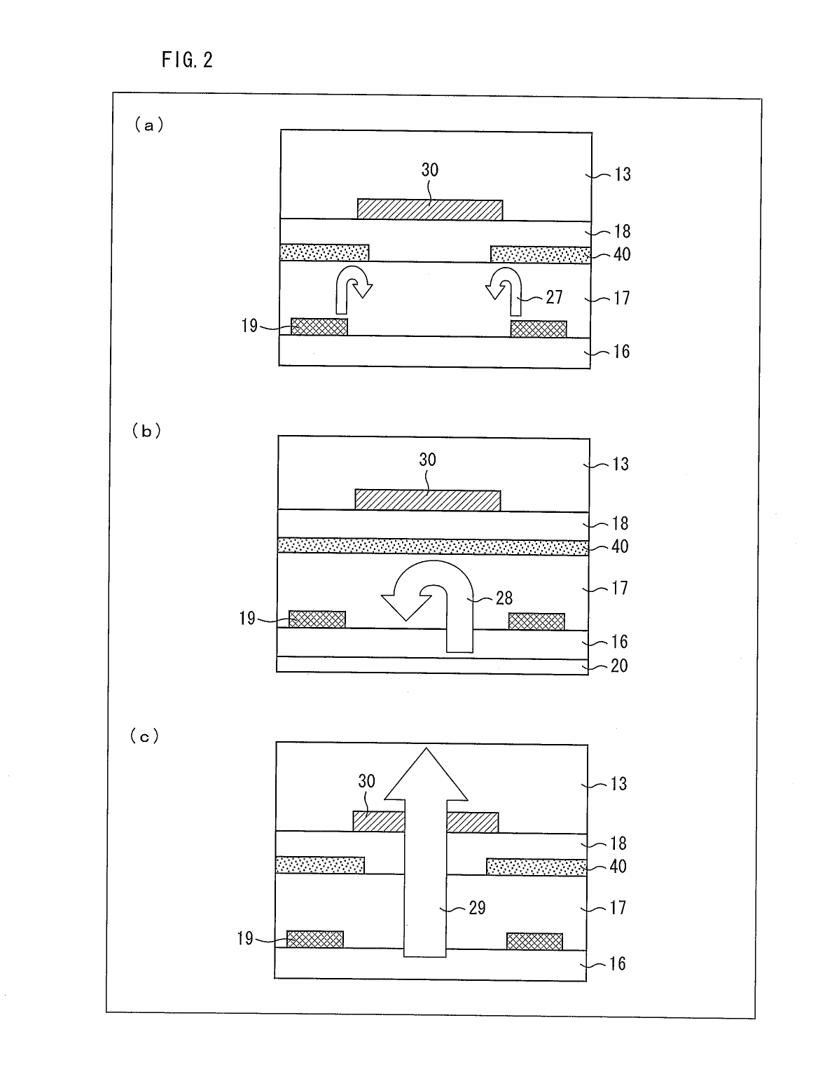

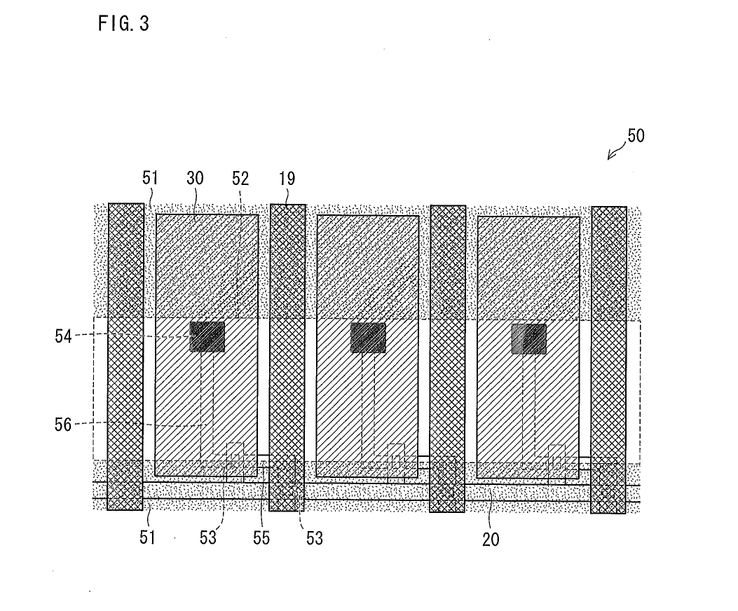

With reference to FIG. 3, the following description will discuss a liquid crystal display element 50 which is another embodiment of the present invention. FIG. 3 is a plan view schematically illustrating the liquid crystal display element 50. The liquid crystal display element 50 is different from the liquid crystal display element 10 in terms of shapes of a common electrode 51 and a TFT 53. Accordingly, in the present embodiment, a description will be provided below as to the common electrode 51 and the TFT 53. Members common between the liquid crystal display element 50 and the liquid crystal display element 10 are given identical reference numerals and explanations thereof are omitted.

### (Common Electrode 51)

The liquid crystal display element 50 is a VA mode liquid crystal display element similarly with the liquid crystal display element 10. However, the liquid crystal display element 10 is driven by dot-inversion driving, whereas the liquid crystal display element 50 is driven by row-inversion driving. Due to a difference in driving method, the common electrode 51 included in the liquid crystal display element 50 and the common electrode 40 included in the liquid crystal display element 10 have different shapes.

One common electrode 51 is provided for a plurality of sub-pixels connected with one scanning line 20. Therefore, the liquid crystal display element 50 is shaped such that individual rows are independent from each other, so that individual common electrodes 51 are electrically insulated from each other.

Individual common electrodes 51 are connected with a CS driver for controlling a storage capacitance. In order that sub-pixels connected with the scanning lines 20 have suitable storage capacitances, the CS driver supplies suitable signals to the common electrodes 51.

On a plan view, each of the common electrodes 51 is shaped so as to cover an entire region where the scanning line 20 is provided and to cover a part of a region where the signal line 19 is provided. The common electrode 51 in accordance with the present embodiment has a rectangular shape. However, the shape of the common electrode 51 is not limited to a rectangle as long as the common electrode 51 meets the aforementioned configuration.

Since the common electrode 51 has the aforementioned shape, it is possible to subdue Cgd which is a parasitic capacitance between the scanning line 20 and the pixel electrode 30 and a part of Csd which is a parasitic capacitance between the signal line 19 and the pixel electrode 30.

Therefore, also in the liquid crystal display element 50 which is a vertical electric field type and is driven by row-inversion driving, it is possible to subdue an influence of a parasitic capacitance on display quality. That is, it is possible to improve display quality of the liquid crystal display element 50.

### (TFT)

A TFT included in the liquid crystal display element 50 is a TFT of a top-gate type. Each sub-pixel region has two TFTs near an intersection between the scanning line 20 and the signal line 19. The TFT has a gate electrode 53, a drain electrode 54, an SI path 55, and an SI path 56. The TFT is different from the TFT included in the liquid crystal display element 10 in terms of shapes of the SI path and the gate electrode.

In the liquid crystal display element 50, a conductive film which constitutes one gate electrode 53 is provided so as to extend from the scanning line 20 in a direction perpendicular to the scanning line 20 (see FIG. 3). This conductive film is made of the same material as that of the scanning line 20.

The SI path 55 intersects the scanning line 20. Another gate electrode 53 is provided at this intersection. The SI path 55 connects said one gate electrode 53 with said another gate electrode 53. Furthermore, the SI path 55 is connected with, at a portion crossing the scanning line 20, the signal line 19 which also serves as a source electrode. The SI path 56 connects one of the two TFTs with the drain electrode 54.

On an interface between (i) the gate electrode 53 and (ii) the SI path 55 and the SI path 56, there are provided a gate insulating film and a channel layer. The SI path 55 and the SI path 56 are each made of silicon.

### Third Embodiment

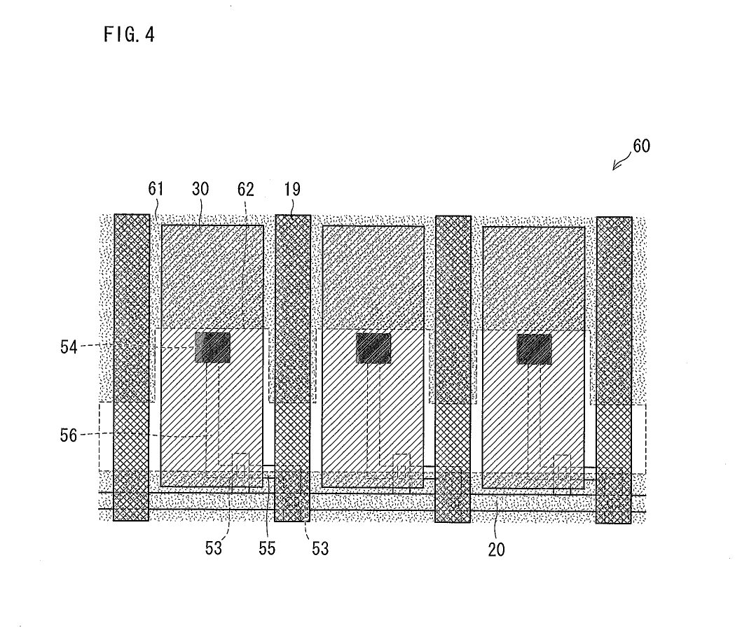

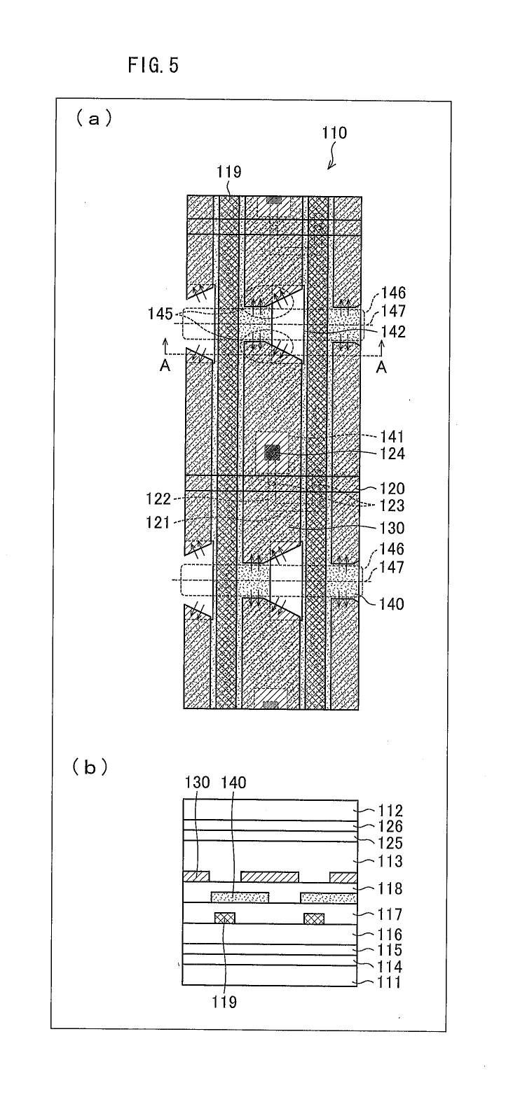

With reference to FIG. 4, the following description will discuss a liquid crystal display element 60 which is still another embodiment of the present invention. A common electrode 61 included in the liquid crystal display element 60 is different from the common electrode 51 included in the liquid crystal display element 50 in terms of the shape of an opening. The common electrode 51 has a rectangular shape. Accordingly, when a length of the common electrode 51 in a direction parallel to the signal line is regarded as a width of the common electrode 51, the width is always constant.

In contrast, a width of the common electrode 61 is not constant. The width of the common electrode 61 is larger at a region where the signal line 19 is provided and at a surrounding region surrounding that region than at a region other than that region and the surrounding region.

This allows the common electrode 61 to cover a larger region out of the region where the signal line 19 is provided. Accordingly, the liquid crystal display element 60 can subdue a parasitic capacitance Csd between the signal line 19 and the pixel electrode 30 more effectively than the liquid crystal display element 50. That is, the liquid crystal display element 60 can further improve display quality than the liquid crystal display element 50 can do.

### Fourth Embodiment

### (Liquid Crystal Display Element 110)

With reference to FIGS. 5 to 7, the following description will discuss a liquid crystal display element 110 in accordance with one embodiment of the present invention. (a) of FIG. 5 is a plan view schematically illustrating the liquid crystal display element 110. (b) of FIG. 5 is a cross sectional view of the liquid crystal display element 110 taken along the line A-A of (a) of FIG. 5. As illustrated in FIG. 5, the liquid crystal display element 110 is based on the configuration of the liquid crystal display element 10 (see FIG. 1). That is, the liquid crystal display element 110 includes a glass substrate 111 which is one of a pair of transparent substrates, a glass substrate 112 which is the other of the pair of transparent substrates, a liquid crystal layer 113, a base coat (BC) 114, a first insulating film 115, a second insulating film 116, an organic insulating film 117, a third insulating film 118, signal lines 119, scanning lines 120, SI paths 121, SI paths 122, gate electrodes 123, drain electrodes 124, a counter electrode 125, a color filter 126, pixel electrodes 130 which are transparent pixel electrodes, and a common electrode 140 which is a transparent common electrode.

In (a) of FIG. 5, only the SI path 121, the SI path 122, the gate electrode 123, the drain electrode 124, and the opening 141 in a sub-pixel sandwiched between two signal lines 119 are illustrated. The same can be said about FIGS. 6, 8 through 10.

In the present embodiment, a description will be provided below as to the scanning lines 120, the counter electrode 125, the pixel electrodes 130, and the common electrode 140 which are characteristics of the liquid crystal display element 110. Members other than these are common among the liquid crystal display element 110 and the liquid crystal display element 10 and so explanations thereof are omitted.

### (Common Electrode 140)

As illustrated in (a) of FIG. 5, the common electrode 140 included in the liquid crystal display element 110 includes cutout sections 142 as well as openings 141. Each of the cutout sections 142 may be provided at a pixel boundary region 146 between the pixel electrodes 130 adjacent in a signal line direction, so as not to face at least the pixel electrodes 130. In the present embodiment, the cutout section 142 having a rectangular shape is illustrated in (a) of FIG. 5. However, the cutout section 142 is not particularly limited in shape.

It is preferable that the cutout section 142 is positioned such that a part of the cutout section 142 does not face the transparent pixel electrode but other part of the cutout section 142 faces the pixel electrode 130. Furthermore, it is preferable that the cutout section 142 is positioned so as to be in a vicinity of one of two signal lines 119 which are provided on respective sides of the pixel electrode 130. What merits are obtained by a part of the cutout section 142 facing the pixel electrode 130 and the cutout section 142 being in a vicinity of one of the signal lines 119 will be described later.

In the present embodiment, a description will be provided below as to a case where a part of the cutout section 142 faces the pixel electrode 130 and the cutout section 142 is in a vicinity of one of the signal lines 119.

(a) of FIG. 6 is a plan view schematically illustrating the liquid crystal display element 110 similarly with (a) of FIG. 5. (b) of FIG. 6 is a cross sectional view illustrating the liquid crystal display element 110 taken along the line B-B of (a) of FIG. 6. (c) of FIG. 6 is a cross sectional view illustrating the liquid crystal display element 110 taken along the line C-C of (a) of FIG. 6.

As illustrated in (a) of FIG. 6, the line B-B is a line which is parallel to the signal line 119 and which includes the cutout section 142. Accordingly, as illustrated in (b) of FIG. 6, the common electrode 140 is not provided at the pixel boundary region 146. The liquid crystal layer 113 corresponding to a region where the common electrode 140 is not provided is hereinafter referred to as a liquid crystal layer 113a.

On the other hand, the line C-C is a line which is parallel to the signal line 119 and which does not include the cutout section 142. Accordingly, as illustrated in (c) of FIG. 6, in the pixel boundary region 146, the pixel electrode 130 is not provided, but the common electrode 140 is provided. The liquid crystal layer 113 corresponding to a region where the pixel electrode 130 is not provided but the common electrode 140 is provided is hereinafter referred to as a liquid crystal layer 113b.

In the liquid crystal display element 110, an identical voltage is applied to the common electrode 140 and the counter electrode 125. Accordingly, the liquid crystal layer 113b illustrated in (c) of FIG. 6 is sandwiched between the common electrode 140 and the pixel electrode 130 which have an identical potential. Consequently, only with the arrangement illustrated in (c) of FIG. 6, it would be difficult to apply, on the liquid crystal layer 113b, an electric field effective for controlling orientation of liquid crystal molecules.

On the other hand, the liquid crystal layer 113a illustrated in (b) of FIG. 6 is hardly influenced by the common electrode 140. Accordingly, on the liquid crystal layer 113a, an electric field effective for controlling orientation of liquid crystal molecules is applied in accordance with a voltage applied across the pixel electrode 130 and the counter electrode 125. The electric field applied on the liquid crystal layer 113a is extended in a scanning line direction. Consequently, the electric field generated in accordance with the voltage applied across the pixel electrode 130 and the counter electrode 125 is applied not only on the liquid crystal layer 113a but also on the liquid crystal layer 113b.

Consequently, in the liquid crystal display element 110, it is possible to regulate alignment of the liquid crystal molecules included in the liquid crystal layer 113b. An arrow illustrated in (a) of FIG. 6 indicates an alignment direction 145 of liquid crystal molecules. The alignment direction 145 near the line B-B and the alignment direction 145 near the line C-C are different from each other. However, the alignment directions 145 are regulated orderly by application of effective electric fields on the liquid crystal layers 113a and 113b. That is, with the cutout section 142, the liquid crystal display element 110 can regulate a center of alignment of liquid crystal molecules in the pixel boundary region 146. It is known that in a case where it is difficult to regulate the center of alignment of liquid crystal molecules in the pixel boundary region 146, display deficiency such as roughness appears in an image displayed by the liquid crystal display element, so that display quality of the liquid crystal display element drops. Since the liquid crystal display element 110 can regulate the center of alignment of liquid crystal molecules in the pixel boundary region 146, it is possible to subdue display deficiency such as roughness.

The liquid crystal display element 110 is based on the configuration of the liquid crystal display element 10. Accordingly, the liquid crystal display element 110 can subdue a parasitic capacitance between the scanning line and the pixel electrode and a parasitic capacitance between the signal line and the pixel electrode, without sacrificing luminance of the liquid crystal display element 110. In other words, the liquid crystal display element 110 can improve display quality without sacrificing luminance of the liquid crystal display element 110. This is applicable to the liquid crystal display elements in accordance with Fifth to Seventh Embodiments.

It is preferable that a part of the cutout section 142 is positioned to face the pixel electrode 130. This allows further effectively subduing an influence of the common electrode 140 on liquid crystal molecules included in the pixel boundary region 146. Therefore, the liquid crystal display element 110 can regulate, with more precision, the center of alignment of liquid crystal molecules included in the pixel boundary region 146.

Furthermore, it is preferable that the cutout section 142 is positioned to be in a vicinity of one of two signal lines 119 which are provided on respective sides of the pixel electrode 130. In other words, it is preferable that in each sub-pixel region, the shape of the common electrode 140 is asymmetrical with respect to a line which is parallel to the signal line 119 and which passes through a center of the pixel. This allows distribution of an electric field in the pixel boundary region 146 to be localized on one side in a scanning line direction. Consequently, the liquid crystal display element 110 can regulate, with more precision, the center of alignment of liquid crystal molecules included in the pixel boundary region 146.

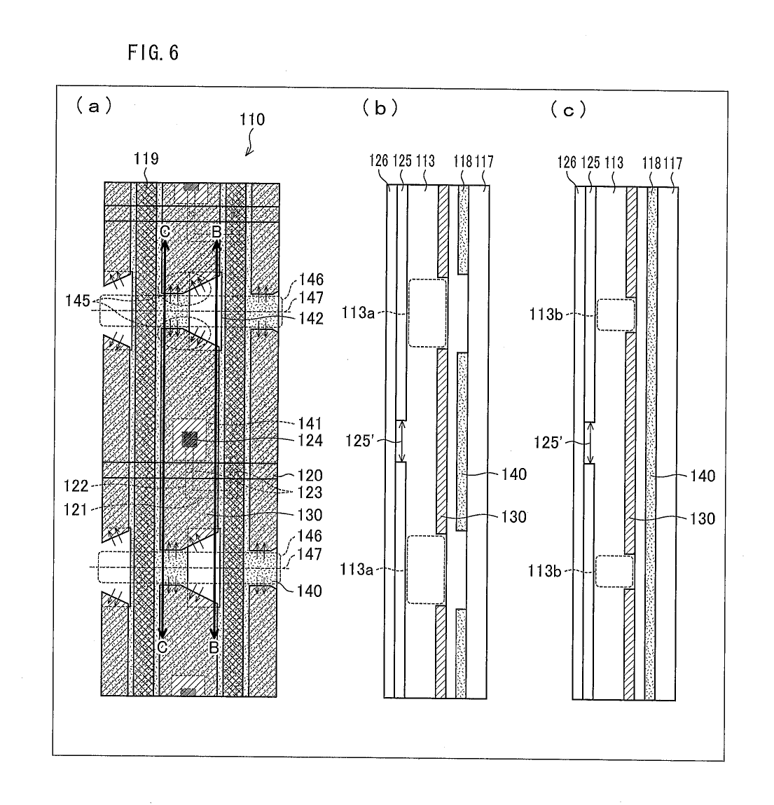

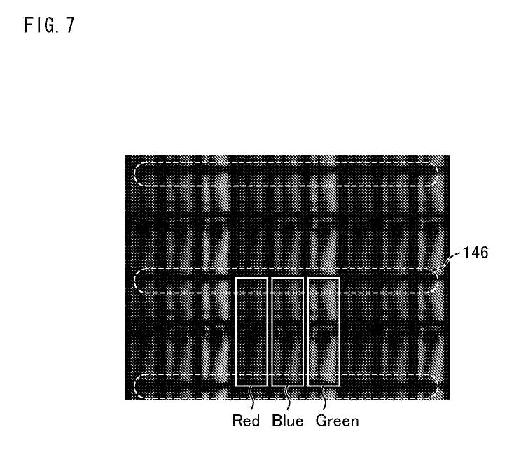

FIG. 7 is a view illustrating an optical microscopic image of the liquid crystal display element 110 in a state where red, green, and blue sub-pixels display respective colors. FIG. 7 illustrates that in each sub-pixel in the pixel boundary region 146, the center of alignment is positioned identically.

### (Counter Electrode 125)

As illustrated in (b) and (c) of FIG. 6, it is preferable that the counter electrode 125 includes an alignment regulating section 125′ in order to more precisely regulate alignment of liquid crystal molecules. The alignment regulating section 125′ may be, for example, a circular hole or a protrusion such as a rib.

In this configuration, the alignment regulating section 125′ is preferably positioned to face the opening 141. There is a possibility that the alignment regulating section 125′ and the opening section 141 both drop optical transmittance. By positioning the alignment regulating section 125′ and the opening section 141 to face each other, it is possible to subdue drop of optical transmittance in other regions in a pixel.

### (Scanning Line 120)

The scanning line 120 included in the liquid crystal display element 110 is positioned to be near a center of a pixel (which center substantially corresponds to a position where the drain electrode 124 is provided) and to face the pixel electrode 130 (see (a) of FIG. 5). Since the alignment regulating section 125′ and the opening 141 are provided near the center of the pixel, optical transmittance at the region is not high. By providing the region with the scanning line 120, it is possible to subdue drop of optical transmittance in other regions in the pixel. In other words, by positioning the scanning line 120 to be near the center of the pixel and to face the pixel electrode 130, it is possible to enhance an open area ratio of the liquid crystal display element 110.

### (Pixel Electrode 130)

The pixel electrode 130 included in the liquid crystal display element 110 is made of a transparent conductive material similarly with the pixel electrode 30 included in the liquid crystal display element 10. It is preferable that out of edges of the pixel electrode 130 in a signal line direction, at least a part of each edge of the pixel electrode 130 which edge faces the cutout section 142 has an inclination which is monotonously closer to a pixel boundary line 147 as said at least a part of each edge is farther from one of the two signal lines in the vicinity of which one the cutout section 142 is provided. By the pixel electrode 130 having such an inclined edge, it is possible to more precisely regulate the center of alignment of liquid crystal molecules included in the pixel boundary region 146. Consequently, it is possible to more surely subdue display deficiency such as roughness due to variations in alignment of liquid crystal molecules. Furthermore, since the cutout section 142 is shaped in such a manner that a part of the cutout section 142 faces the pixel electrode 130, an effect yielded by the pixel electrode 130 having an inclined edge is further enhanced.

The pixel electrode 130 may be arranged such that edges of the pixel electrode 130 which edges face the cutout section 142 are all inclined edges.

### Fifth Embodiment

### (Liquid Crystal Display Element 150)

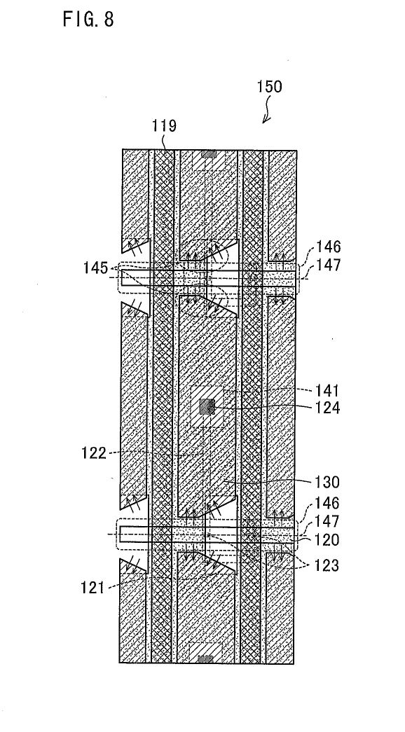

With reference to FIG. 8, the following description will discuss a liquid crystal display element 150 in accordance with one embodiment of the present invention. FIG. 8 is a plan view schematically illustrating the liquid crystal display element 150. The liquid crystal display element 150 is a liquid crystal display element obtained by arranging the liquid crystal display element 110 of Fourth Embodiment to change the positions of the scanning lines 120. As illustrated in FIG. 8, the scanning line 120 included in the liquid crystal display element 150 is provided at the pixel boundary region 146.

By the scanning line 120 being provided at the pixel boundary region 146 which is far from the center of the pixel, it is possible to secure a long distance between (i) a connection section connected with the drain electrode 124 of a TFT (driving element) and with the pixel electrode 130 and (ii) the gate electrode 123 of the TFT. With the arrangement, similarly with the liquid crystal display element 110, the liquid crystal display element 150 can subdue display deficiency such as roughness and improve a yield in the production step.

### Sixth Embodiment

### (Liquid Crystal Display Element 160)

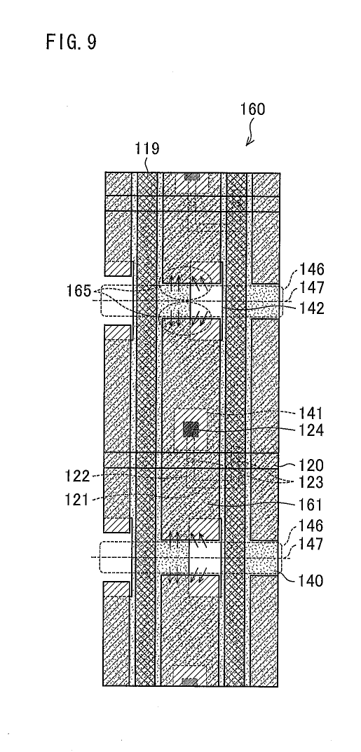

With reference to FIG. 9, the following description will discuss a liquid crystal display element 160 in accordance with one embodiment of the present invention. FIG. 9 is a plan view schematically illustrating the liquid crystal display element 160. The liquid crystal display element 160 is different from the liquid crystal display element 110 in accordance with Fourth Embodiment in that the liquid crystal display element 160 includes pixel electrodes 161 having a rectangular shape. The pixel electrode 161 having a rectangular shape can apply a voltage on a wider range of a pixel region than the pixel electrode 130 having an inclined edge can do. That is, the liquid crystal display element 160 including the pixel electrodes 161 having a rectangular shape has an improved open area ratio. Consequently, the liquid crystal display element 160 has increased luminance.

Since the liquid crystal display element 160 includes the cutout sections 142, it is possible to regulate a center of alignment of liquid crystal molecules included in the pixel boundary region 146. Accordingly, the liquid crystal display element 160 can subdue display deficiency such as roughness and has high luminance.

### Seventh Embodiment

### (Liquid Crystal Display Element 170)

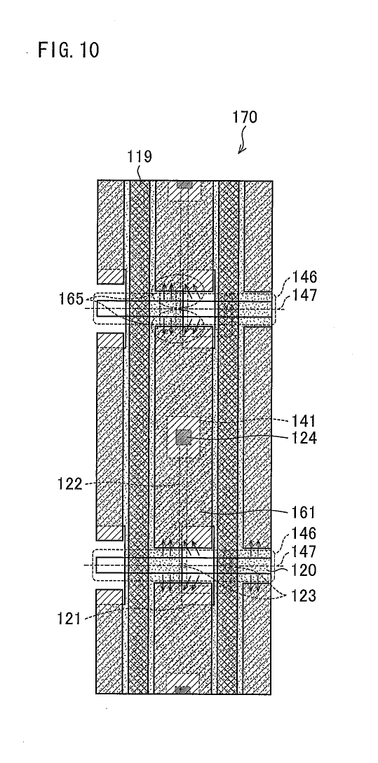

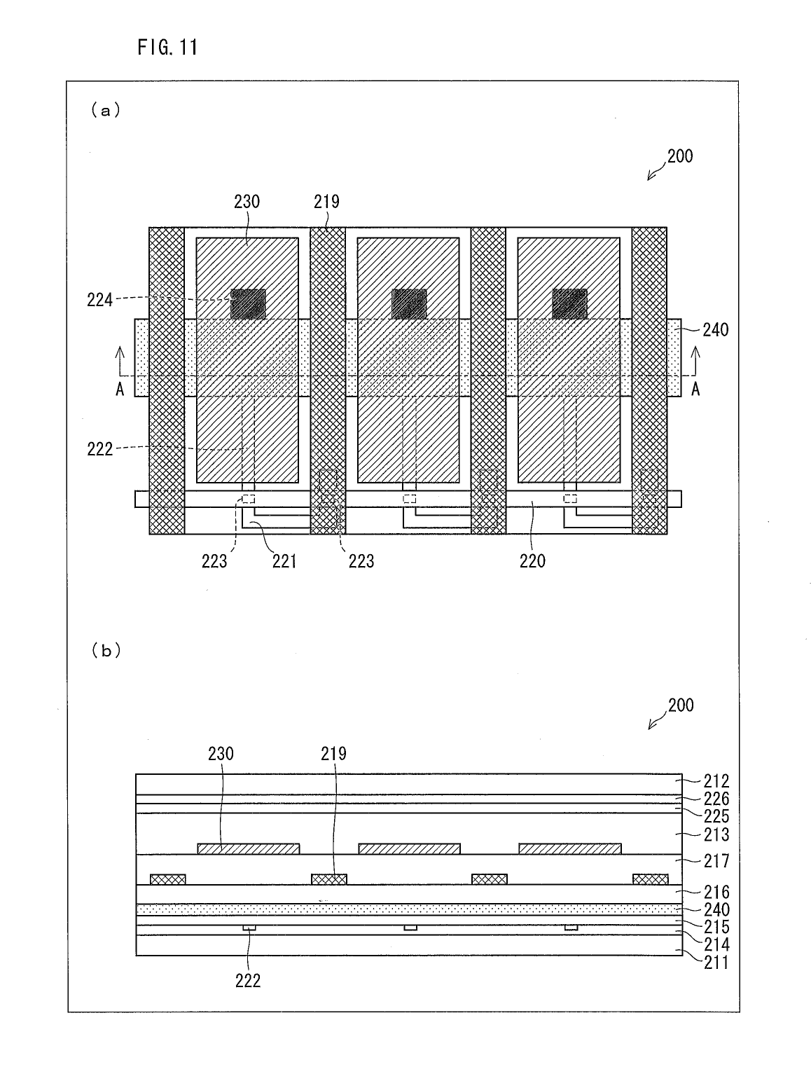

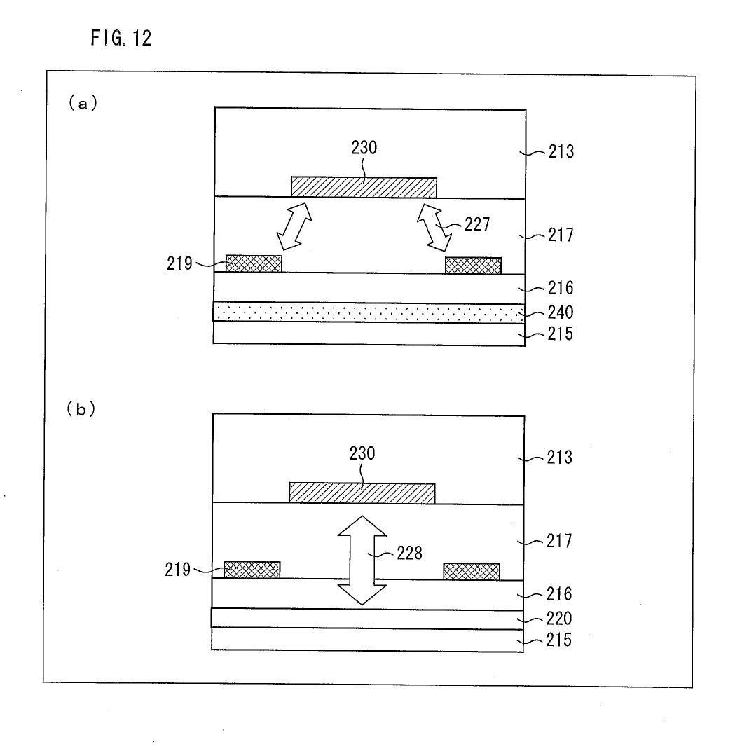

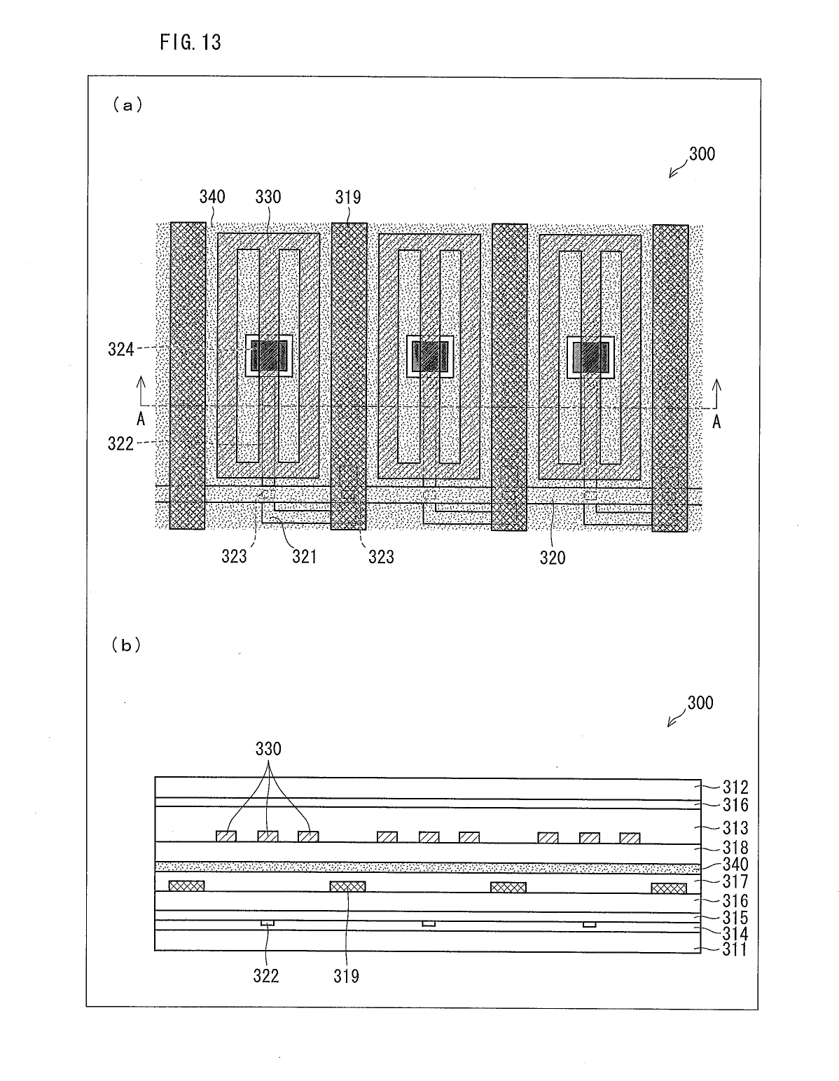

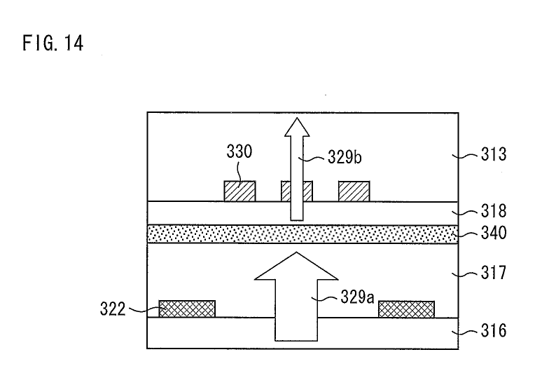

With reference to FIG. 10, the following description will discuss a liquid crystal display element 170 in accordance with one embodiment of the present invention. FIG. 10 is a plan view schematically illustrating the liquid crystal display element 170. The liquid crystal display element 170 is a liquid crystal display element obtained by arranging the liquid crystal display element 160 in accordance with Sixth Embodiment to change the positions of the scanning lines 120. As illustrated in FIG. 10, the scanning line 120 included in the liquid crystal display element 170 is provided at the pixel boundary region 146.

By the scanning line 120 being provided at the pixel boundary region 146 which is far from the center of the pixel, it is possible to secure a long distance between (i) a connection section connected with the drain electrode 124 of a TFT (driving element) and with the pixel electrode 130 and (ii) the gate electrode 123 of the TFT. With the arrangement, the liquid crystal display element 170 can improve a yield in the production step.

Furthermore, the liquid crystal display element 170 includes a pixel electrode 161 having a rectangular shape. Consequently, the liquid crystal display element 170 has an improved open area ratio and increased luminance.

Besides, since the liquid crystal display element 170 includes the cutout section 142 similarly with the liquid crystal display elements in accordance with other embodiments of the present invention, it is possible to regulate a center of alignment of liquid crystal molecules included in the pixel boundary region 146. Accordingly, the liquid crystal display element 170 can subdue display deficiency such as roughness, has high luminance, and can improve a yield in the production step.

It is preferable that a liquid crystal display device in accordance with one embodiment of the present invention includes any one of the liquid crystal display elements in accordance with Fourth to Seventh Embodiments. With this arrangement, the liquid crystal display device in accordance with one embodiment of the present invention can yield an effect similar to that yielded by the liquid crystal display elements in accordance with Fourth to Seventh Embodiments.

### SUMMARY

A liquid crystal display element in accordance with first aspect of the present invention is a liquid crystal display element, including a pair of transparent substrates (111, 112) and a liquid crystal layer (113) provided between the pair of transparent substrates (111, 112),

one (111) of the pair of transparent substrates being provided with:

scanning lines (120);

signal lines (119) orthogonal to the scanning lines (120);

driving elements (TFT including the gate electrode 123, the SI path 121, the SI path 122, and the drain electrode 124) connected with the signal lines and the scanning lines;

transparent pixel electrodes (130) provided at a layer above a layer at which the scanning lines (120) and the signal lines (119) are provided, the transparent pixel electrodes (130) being connected with the driving elements (TFT); and

a transparent common electrode (140),
the transparent common electrode (140) being provided at a layer between (i) the scanning lines (120) and the signal lines (119) and (ii) the transparent pixel electrodes (130),
the transparent common electrode (140) covering a location which faces at least one of at least a part of the scanning lines (120) and at least a part of the signal lines (119),
the transparent common electrode (140) having openings (141) at locations facing the transparent pixel electrodes (130), respectively, and
the transparent common electrode (140) having a cutout section (142) at a pixel boundary region (146) in such a manner that the cutout section (142) exists at least at a part of the pixel boundary region (146) which part does not face the transparent pixel electrodes (130), the pixel boundary region (146) being a region between adjacent ones of the transparent pixel electrodes (130) which ones are adjacent in a signal line direction,

the other (112) of the pair of transparent substrates being provided with a counter electrode (125).

With the arrangement, in the liquid crystal display element in accordance with one aspect of the present invention, the transparent common electrode is provided at a layer between (i) the scanning lines and the signal lines and (ii) the transparent pixel electrodes. Furthermore, at least one of at least a part of the scanning lines and at least a part of the signal lines is covered with the transparent common electrode. In the liquid crystal display element having this configuration, in a case where at least a part of the scanning line is covered with the transparent common electrode, a part of the scanning line and the pixel electrode are shielded from each other by the transparent common electrode. Similarly, in a case where at least a part of the signal line is covered with the transparent common electrode, a part of the signal line and the pixel electrode are shielded from each other by the transparent common electrode. This subdues a parasitic capacitance between (i) at least one of at least a part of the scanning line and at least a part of the signal line and (ii) the pixel electrode.

Furthermore, the transparent common electrode has openings at locations facing the transparent pixel electrodes. This allows more amount of light to enter the liquid crystal layer without being transmitted by the transparent common electrode. Consequently, the liquid crystal display element has improved luminance.

As described above, with the liquid crystal display element in accordance with one aspect of the present invention, it is possible to subdue a parasitic capacitance between (i) the scanning line and the signal line and (ii) the pixel electrode, without sacrificing luminance of the liquid crystal display element of a vertical electric field type.

Furthermore, with the arrangement, the transparent pixel electrode included in the liquid crystal display element in accordance with one embodiment of the present invention has a cutout section at a pixel boundary region in such a manner that the cutout section exists at least at a part of the pixel boundary region which part does not face the transparent pixel electrodes. This allows regulating an electric field generated in the pixel boundary region, and consequently allows regulating alignment of liquid crystal molecules included in the pixel boundary region. Therefore, it is possible to subdue display deficiency such as roughness due to variations in alignment of liquid crystal molecules.

A liquid crystal display element in accordance with second aspect of the present invention is preferably an arrangement of the first aspect, in which a part of the cutout section (142) is positioned to face the transparent pixel electrodes (130).

With the arrangement, regulation of an electric field generated in the pixel boundary region in a signal line direction is enhanced. Therefore, it is possible to regulate a center of alignment of liquid crystal molecules in the region with more precision, so that it is possible to more surely subdue display deficiency such as roughness due to variations in alignment of liquid crystal molecules.

A liquid crystal display element in accordance with third aspect of the present invention is preferably an arrangement of the first or second aspect, in which the cutout section (142) is provided so as to be in a vicinity of one (119) of two signal lines (119) provided at respective sides of each of the transparent pixel electrodes (130).

With the arrangement, the transparent common electrode included in the display element in accordance with one aspect of the present invention has an asymmetrical shape in the signal line direction. Since the transparent common electrode has an asymmetrical shape in the signal line direction, distribution of strength of an electric field generated in the pixel boundary region is asymmetrical in the signal line direction. Consequently, regulation of the electric field generated in the pixel boundary region in the signal line direction is enhanced. This allows regulating a center of alignment of liquid crystal molecules in the region with more precision, and allows more surely subduing display deficiency such as roughness due to variations in alignment of liquid crystal molecules.

A liquid crystal display element in accordance with fourth aspect of the present invention is preferably an arrangement of the third aspect, in which out of edges of each of the transparent pixel electrodes (130) in a signal line direction, at least a part of each edge of said each transparent pixel electrode (130) which edge faces the cutout section (142) has an inclination which is monotonously closer to the pixel boundary region (147) as the inclined edge is farther from one (119) of the two signal lines (119) in the vicinity of which one the cutout section (142) is provided.

With the arrangement, it is possible to regulate a center of alignment of liquid crystal molecules in the region with more precision, and it is possible to more surely subdue display deficiency such as roughness due to variations in alignment of liquid crystal molecules.

A liquid crystal display element in accordance with fifth aspect of the present invention is preferably an arrangement of one of the first through fourth aspects, in which each of the scanning lines (120) is provided near centers of corresponding pixels so as to face corresponding ones of the transparent pixel electrodes (130).

With the arrangement, each of the scanning lines is provided near centers of corresponding pixels so as to face corresponding ones of the transparent pixel electrodes. A region near the center of a pixel does not have high optical transmittance. By providing the scanning line at the region near the center of a pixel which region does not have high optical transmittance, it is possible to subdue drop in optical transmittance in other regions in the pixel. In other words, an open area ratio of the liquid crystal display device is enhanced.

A liquid crystal display element in accordance with sixth aspect of the present invention is preferably an arrangement of one of the first through fourth aspects, in which each of the scanning lines (120) is provided at the corresponding pixel boundary region (146).

With the arrangement, it is possible to secure a long distance between (i) a gate electrode of the driving element and (ii) a connection section connected with a drain electrode of the driving element and with the transparent pixel electrode. This allows enhancing a yield in production of the liquid crystal display element.

A liquid crystal display device in accordance with seventh aspect of the present invention preferably includes a liquid crystal display element in accordance with one of the first through sixth aspects.

With the arrangement, in the liquid crystal display device including the liquid crystal display element of a vertical electric field type, it is possible to subdue a parasitic capacitance between (i) the scanning line and the signal line and (ii) the pixel electrode. Furthermore, it is possible to subdue display deficiency such as roughness due to variations in alignment of liquid crystal molecules.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is widely usable as a liquid crystal display element and a liquid crystal display device.

### REFERENCE SIGNS LIST

110 Liquid crystal display element
111 Glass substrate (one of transparent substrates)
112 Glass substrate (the other of transparent substrates)
113 Liquid crystal layer
114 Base coat
115 First insulating film
116 Second insulating film
117 Organic insulating film
118 Third insulating film
119 Signal line
120 Scanning line
121 SI path
122 SI path
123 Gate electrode
124 Drain electrode
125 Counter electrode
126 Color filter
130 Pixel electrode (transparent pixel electrode)
140 Common electrode (transparent common electrode)
141 Opening
142 Cutout section
145 Alignment direction
146 Pixel boundary region
147 Pixel boundary line

1. A liquid crystal display element, comprising a pair of transparent substrates and a liquid crystal layer provided between the pair of transparent substrates,
one of the pair of transparent substrates being provided with:
scanning lines;
signal lines orthogonal to the scanning lines;
driving elements connected with the signal lines and the scanning lines;
transparent pixel electrodes provided at a layer above a layer at which the scanning lines and the signal lines are provided, the transparent pixel electrodes being connected with the driving elements; and
a transparent common electrode,
the transparent common electrode being provided at a layer between (i) the scanning lines and the signal lines and (ii) the transparent pixel electrodes,
the transparent common electrode covering a location which faces at least one of at least a part of the scanning lines and at least a part of the signal lines,
the transparent common electrode having openings at locations facing the transparent pixel electrodes, respectively, and
the transparent common electrode having a cutout section at a pixel boundary region in such a manner that the cutout section exists at least at a part of the pixel boundary region which part does not face the transparent pixel electrodes, the pixel boundary region being a region between adjacent ones of the transparent pixel electrodes which ones are adjacent in a signal line direction, the other of the pair of transparent substrates being provided with a counter electrode.

2. The liquid crystal display element as set forth in claim 1, wherein a part of the cutout section is positioned to face the transparent pixel electrodes.

3. The liquid crystal display element as set forth in claim 1, wherein the cutout section is provided so as to be in a vicinity of one of two signal lines provided at respective sides of each of the transparent pixel electrodes.

4. The liquid crystal display element as set forth in claim 3, wherein out of edges of each of the transparent pixel electrodes in a signal line direction, at least a part of each edge of said each transparent pixel electrode which edge faces the cutout section has an inclination which is monotonously closer to the pixel boundary region as said at least a part of each edge is farther from one of the two signal lines in the vicinity of which one the cutout section is provided.

5. The liquid crystal display element as set forth in claim 1, wherein each of the scanning lines is provided near centers of corresponding pixels so as to face corresponding ones of the transparent pixel electrodes.

6. The liquid crystal display element as set forth in claim 1, wherein each of the scanning lines is provided at the corresponding pixel boundary region.

7. A liquid crystal display device, comprising a liquid crystal display element as set forth in claim 1.
